(19) United States
(12) Patent Application Publication
(10) Pub. No.: US 2024/0408562 A1
(43) Pub. Date: Dec. 12, 2024

(54) TUBULAR REACTOR HAVING A FIXED BED WITH A FILTERING ELEMENT

(71) Applicant: COMMISSARIAT A L'ENERGIE ATOMIQUE ET AUX ENERGIES ALTERNATIVES, Paris (FR)

(72) Inventors: Albin CHAISE, Grenoble Cedex 09 (FR); Julien CIGNA, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 18/702,030

(22) PCT Filed: Oct. 6, 2022
(86) PCT No.: PCT/FR2022/051887

§ 371 Date: Apr. 17, 2024

(30) Foreign Application Priority Data
Oct. 19, 2021 (FR) 21 11097

(51) Int. Cl. B01J 8/02; B01J 8/06

(52) U.S. Cl. CPC B01J 8/0214; B01J 8/065; B01J 2208/00884; B01J 2208/00938

(57) ABSTRACT

A tubular reactor includes a bed of catalytic powder confined within an annular space, a hollow insert having a distribution chamber and a collection chamber, and a second wall comprising at least one distributing opening and at least one collecting opening. The reactor has at least one filtering element positioned at the at least one collecting opening and at the at least one distributing opening, preventing the passage of catalytic powder from the annular space to the at least one collection chamber and distribution chamber, and bearing against the outer surface of the second wall and covering the at least one collecting opening and distributing opening and/or being housed inside the at least one collecting opening and distributing opening.

### TECHNICAL FIELD

The present invention relates to the field of exchanger reactors. In particular, the present invention relates to the field of catalytic exchanger reactors using a solid catalyst, and in particular a solid catalyst in powder form, as well as to the field of means for confining such a catalyst.

In this regard, the present invention proposes a catalytic exchanger reactor capable of implementing exothermic organic synthesis methods. These organic compounds may in particular comprise synthetic fuels and combustible.

### PRIOR ART

Catalytic reactors using solid catalysts are widely used for the synthesis of organic compounds such as synthetic fuels or combustibles including natural gas substitutes, dimethyl ether or else methanol.

These compounds are in particular obtained by reaction of hydrogen and carbon monoxide in the presence of an appropriate solid catalyst.

However, the chemical reactions relating to the synthesis of these compounds are very exothermic, and consequently release an amount of heat capable of degrading the solid catalyst. This degradation results in a reduction in the conversion rate of the chemical species present, and a reduction in the selectivity of the reactions involved. Moreover, the solid catalyst is deactivated under the effect of heat.

Thus, in practice, these reactions can be carried out in an exchanger reactor of the tube-and-shell type which comprises a reactive channel provided with the solid catalyst and continuously cooled by a heat transfer fluid. In this type of reactor, the reactive gases circulate axially in the tubes which contain a catalyst, for example in powder form.

However, despite the implementation of cooling by the heat transfer fluid, this type of reactor remains sensitive to the heat released by the reactions occurring in the reactor.

In particular, a hot spot, generally observed near the inlet of the reactive gases, degrades the solid catalyst, and therefore reduces the performance of the exchanger reactor.

In order to limit these effects, the following solutions have been proposed:
a reduction in the volume density of catalyst, in particular by depositing the latter on the walls of the tube or an insert or by diluting it in a non-reactive medium;
a dilution of the reactive gases with part of the products generated to reduce the activity of the reaction;
creating several injection points of one or more reagents to distribute the hot spot area over a larger surface;
a reduction in the dimensions of the tubes or by placing heat-conducting parts therein in order to improve the cooling of the tubes.

However, these solutions are not satisfactory.

Indeed, even though they allow to reduce the effects of the hot spot, they are complex to implement.

Moreover, their implementation reduces the flexibility of use of the exchanger reactor, and makes the latter not very compact.

In order to overcome these problems, provision was then made of an arrangement allowing to balance the distribution of reagents over the entire length of the tubes. This solution then allows to obtain better temperature homogeneity over the entire length of the reactor.

In this regard, documents U.S. Pat. Nos. 3,758,279 A, 4,374,094 A, EP 0 560 157 A1 and U.S. Pat. No. 2,997,374 A propose exchanger reactors implementing a distribution of reagents from an annular distribution space. In particular, these exchanger reactors, of generally cylindrical shape, comprise, arranged coaxially and from the outside of the reactor, a tube, the annular distribution space, a catalyst charge and a collection space.

This arrangement is, however, not satisfactory.

Indeed, the presence of the annular distribution space disposed around the catalyst charge limits heat transfer from the catalyst to the tube, making the cooling systems generally implemented inefficient. It nevertheless remains possible to insert heat-conducting elements into the reactor. However, such a solution remains incompatible with reactors comprising small diameter tubes.

Conversely, document CN 103990420 A proposes to implement an insert provided with a distribution chamber and a collection chamber, disposed in the centre of a tube and defining with the latter an annular space housing the solid catalyst.

However, the arrangement proposed in this document does not allow to distribute it homogeneously within the annular space. More particularly, this arrangement does not allow to obtain an optimal temperature profile within the solid catalyst.

Moreover, a principle of staged distribution of gas in an exchanger reactor is known from European patent application EP 3 827 895 A1 of the Applicant. The reactor includes a catalyst provided in an annular space located between a hollow tube and a hollow insert provided with distribution and collection chambers. The principle of catalyst confinement is not taught and there remains a need to design a solution to this problem of confinement of the catalytic powder bed.

A purpose of the present invention is to propose a fixed-bed tubular reactor allowing more homogeneous distribution of the reagents within the solid catalyst. Another purpose of the present invention is also to propose a fixed-bed tubular reactor allowing a more homogeneous distribution of the heat flow generated within the solid catalyst.

Another purpose of the present invention is also to propose a tubular reactor allowing better cooling management.

Another purpose of the present invention is also to propose a tubular reactor for which the reliability and lifespan are improved compared to reactors known from the prior art.

Another purpose of the present invention is to propose a tubular reactor allowing to optimise (increase) the passage time of the gases in the fixed bed of catalytic powder.

### DESCRIPTION OF THE INVENTION

The invention aims at least at partially overcoming the needs and purposes mentioned above and the disadvantages relating to the embodiments of the prior art.

The object of the invention is therefore, according to one of its aspects, a fixed-bed tubular reactor which extends, along a longitudinal axis, between a first end and a second end,
the reactor comprising a bed of catalytic powder confined within an annular space delimited by a first wall of a hollow tube and a second wall of a hollow insert, disposed in the hollow tube and coaxially with the latter,
the hollow insert comprising at least one distribution chamber and at least one collection chamber, separated from each other by a separating wall, and comprising, respectively, a gas admission opening at the first end and a gas evacuation opening at the second end, the second wall comprising at least one distributing opening and at least one collecting opening, which extend over a length, the distributing opening allowing the distribution of a gas capable of being admitted through the admission opening of the distribution chamber towards the annular space, and the collecting opening allowing the collection of the gas distributed in the annular space by the collection chamber,
characterised in that the reactor includes at least one filter element positioned at said at least one collecting opening between said at least one collection chamber and the annular space, as well as at said at least one distributing opening between said at least one distribution chamber and the annular space, said at least one filter element preventing the passage of catalytic powder from the annular space respectively to said at least one collection chamber and said at least one distribution chamber,
said at least one filter element bearing against the outer surface of the second wall and completely covering said at least one collecting opening and said at least one distributing opening and/or being housed at least partially inside said at least one collecting opening and said at least one distributing opening.

The reactor according to the invention may further include one or more of the following features taken individually or in any possible technical combination.

It is understood that to the extent that the reactor according to the present invention is tubular, the hollow tube and the hollow insert are necessarily of cylindrical shape but not necessarily cylindrical of revolution.

Moreover, since the hollow insert is disposed in the hollow tube and coaxially with the latter, the annular space can have a symmetry of revolution.

Thus, the reactor according to the present invention allows to distribute the reactive gases, due to the extent of the distributing opening, relatively homogeneously in the annular space. The latter then react with the bed of catalytic powder over the entire section covered by the distributing opening. The products resulting from the reaction of the gases, as well as the unreacted gases, are collected at the collecting opening and evacuated from the reactor through the evacuation opening opposite the admission opening.

This arrangement for which the admission of the gases is done through one end and the evacuation through the other end allows a better distribution of the reactive species (the gases) in the annular space, and consequently a better distribution of the heat likely to be released during the reaction of reactive species in the annular space.

This better distribution of the heat released allows to consider a less powerful cooling system and therefore smaller dimensions.

The arrangement according to the present invention therefore allows to consider a more compact reactor, and with improved reliability compared to the tubular reactors known from the prior art.

Said at least one filter element may be presented at least partly in the form of one or more filter sheets positioned against the outer surface of the second wall of the hollow insert and completely covering said at least one collecting opening and said at least one distributing opening by bearing on the outer surface of the second wall on either side of said openings.

The filter sheet(s) may include a fabric, a felt, for example made of glass fibres, metal fibres, carbon fibres, a metal grid and/or a micro-perforated metal sheet, among others.

In addition, the filter sheet(s) may be in a shape that is at least partly cylindrical, in particular in the form of one or more portions of cylindrical shape, matching the cylindrical shape of the outer surface of the second wall of the insert and fitted onto the insert.

The filter sheet(s) can be secured to the insert by spot welding, by brazing and/or by means of at least one ligature around the insert and the filter sheet(s), for example one or more metal wires wound around them.

Furthermore, the reactor may include at least one compartment at each of said at least one collecting opening and a distributing opening, said at least one filter element being at least partly housed inside said at least one compartment and said at least one collecting opening and said at least one distributing opening.

A filter element can advantageously be introduced inside each compartment, in contact with the inner wall(s) of the compartment.

Each compartment may include one or more openings allowing the circulation of gases.

In addition, one or more compartments can be formed by means of a local modification, at one or more collecting opening and distributing opening, of the second wall of the insert.

One or more compartments can be formed by means of a cut membrane placed in one or more collecting and distributing openings.

Furthermore, said at least one filter element can contact the hollow tube so as to allow centring the insert relative to the hollow tube.

Moreover, the compartment(s) and the insert can form a single piece.

The at least one distribution chamber can be closed at the second end, and the at least one collection chamber can be closed at the first end.

The reactor may comprise at the first end and at the second end, respectively, a distributing space and a collecting space between which the insert is disposed.

The catalytic powder can be retained in the annular space by a fibrous material seal at each end of the annular space.

The fibrous material seal can be held in compression against the catalytic powder by a spring, the spring abutting against a retaining plate mechanically connected to the tube.

The fibrous material seal in combination with the spring(s) allows to better compact the catalytic powder and prevent attrition of the latter during handling or transport of the reactor.

The outer wall may have no opening on a first section and a second section which extend, respectively, from the first end and the second end, the first section and the second section being overlapping with the bed of powder over a height H, the height H being comprised between 0.5 times and 10 times, advantageously comprised between 1 time and 2 times, the distance separating a distributing opening from an immediately adjacent collecting opening, and measured along the outer surface of the outer wall.

Thus, such an arrangement allows to impose a passage time on the reactive gases capable of penetrating into the annular space via the fibrous seal.

The hollow insert can be provided with centring means maintaining the latter in a coaxial position with the hollow tube; advantageously, the centring means comprise bumps formed on the second wall.

These centring means allow easier assembly of the reactor.

The surface of a section of the distribution chamber along a section plane transverse to the longitudinal axis can decrease from the first end towards the second end, advantageously, said surface is zero at the second end.

Additive manufacturing methods, and in particular 3D manufacturing techniques, allow to produce these complex structures in the form of a single piece.

The surface of a section of the collection chamber along a section plane transverse to the longitudinal axis can increase from the first end towards the second end; advantageously, said surface is zero at the first end.

The collecting opening and the distributing opening can have a width comprised between 1/100 and ½, advantageously between 1/20 and ¼, of the diameter of the hollow tube.

The hollow insert can form a single piece.

### BRIEF DESCRIPTION OF THE DRAWINGS

The invention can be better understood upon reading the detailed description which follows, non-limiting examples of its implementation, as well as upon examining the schematic and partial figures of the appended drawing, on which:

FIG. 1 is a schematic representation of a fixed bed tubular reactor according to a first variant of the present invention, in particular FIG. 1 shows the reactor according to a longitudinal section plane passing through a longitudinal axis XX′ of the reactor;

FIG. 2 is a schematic representation of the reactor of FIG. 1 along a transverse section plane perpendicular to the longitudinal axis;

FIG. 3 is a representation of a filter element, and in particular of a filter formed of four planes of fibres, capable of being used in the tubular reactor according to the present invention;

FIG. 4, FIG. 5 and FIG. 6 are representations in partial cross section of inserts equipped with filter elements in accordance with the invention,

FIG. 7 is a representation in partial cross section of another example of insert equipped with a compartment with filter element in accordance with the invention,

FIG. 8 and FIG. 9 are representations in partial cross section, respectively before and after cutting a membrane, allowing to illustrate obtaining another example of compartment with filter element in accordance with the invention,

FIG. 10 and FIG. 11 are representations in partial cross section of other embodiments of compartments with filter elements in accordance with the invention positioned in contact with the hollow tube,

FIG. 12 is a representation of a fixed-bed tubular reactor according to the first variant of the present invention at the first end illustrating the arrangement of the seal and the spring retaining the bed of catalytic powder;

FIG. 13 is a schematic representation of the hollow insert according to the section plane AA′ of FIG. 12;

FIG. 14 is a schematic representation of an insert according to a second variant of the present invention, in particular FIG. 14 shows the reactor along a longitudinal section plane passing through a longitudinal axis XX′ of the reactor;

FIG. 15A, FIG. 15B, FIG. 15C, FIG. 15D and FIG. 15E are views, respectively, along section planes A, B, C, D and E of the hollow insert shown in FIG. 14;

FIG. 16 is a schematic representation of an insert according to a third variant of the present invention, in particular FIG. 16 shows the reactor along a longitudinal section plane passing through a longitudinal axis XX′ of the reactor; and

FIG. 17 and FIG. 18 are views, respectively, along the section planes CC′ and DD′ of the hollow insert shown in FIG. 16.

In all these figures, identical references can designate identical or similar elements.

In addition, the different parts shown in the figures are not necessarily on a uniform scale, to make the figures more readable.

### Detailed Description of Particular Embodiments

The present invention relates to a tubular exchanger reactor with a fixed catalytic powder bed. In particular, the bed of catalytic powder is confined within an annular space delimited by a first wall of a hollow tube and a second wall of a hollow insert disposed in the tube and coaxially with the latter.

The hollow insert according to the present invention is in particular arranged to allow admission of reactive gases along a first end of the reactor into a distribution chamber of the insert. The latter are then distributed over a section of the annular space extended over a length L, through a distributing opening allowing gases to pass from the distribution chamber to the annular space.

The products resulting from the reaction between reactive species are then collected, via a collecting opening, in a collection chamber of the hollow insert, isolated from the distribution chamber by a separating wall.

The products are evacuated through an evacuation opening in the collection chamber at the second end.

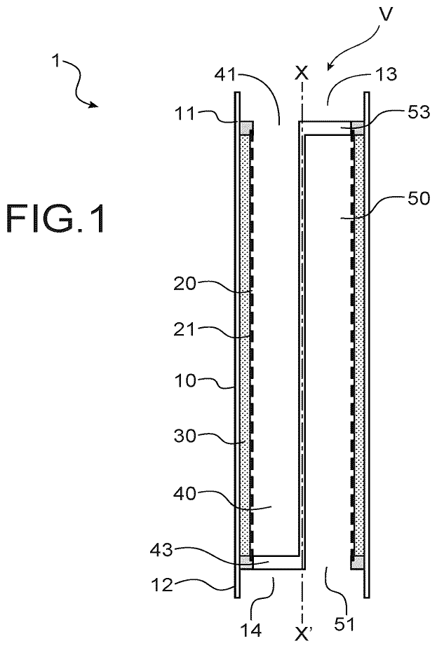

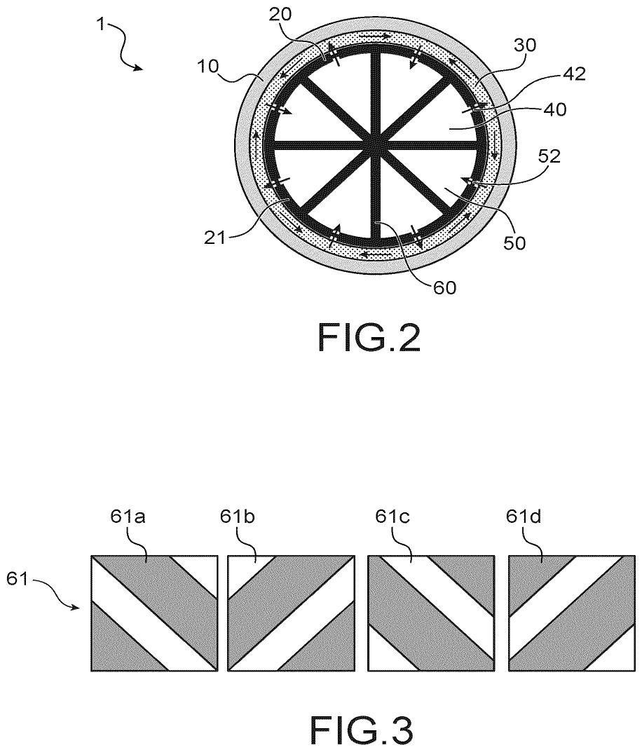

An exemplary embodiment of a tubular fixed-bed reactor according to a first variant of the present invention can be seen in FIGS. 1 and 2.

The tubular reactor 1 according to the present invention comprises a hollow tube 10 which extends along a longitudinal axis XX′, between a first end 11 and a second end 12.

The hollow tube 10 can have a symmetry of revolution around the longitudinal axis XX′. The hollow tube 10 may comprise a metal, and in particular a metal selected from: steel, aluminium alloy, copper alloy, nickel alloy, among others. The diameter of the inner surface of the hollow tube 10 can be comprised between 5 mm and 100 mm.

The wall, called the first wall, forming the hollow tube 10 may have a thickness comprised between 0.5 mm and 10 mm. The hollow tube 10 can have a length comprised between 10 times and 200 times its inner diameter.

The tubular reactor 1 also comprises a hollow insert 20 which also extends along the longitudinal axis XX′ and has a cylindrical outer shape. The hollow insert 20 can be a single piece.

The hollow insert 20 is in particular housed in the volume V of the hollow tube 10 coaxially with the latter. In particular, the insert 20 comprises a wall, called the second wall 21, which delimits an annular space 30 with the first wall of the hollow tube.

The annular space 30 is, in this regard, filled with a catalytic powder which will be the seat of the conversion reactions of reactive gases capable of passing through the tubular reactor 1.

The annular space 30 may have a thickness, defined as the distance between the first wall and the second wall, comprised between 2% and 20% of the inner diameter of the first wall.

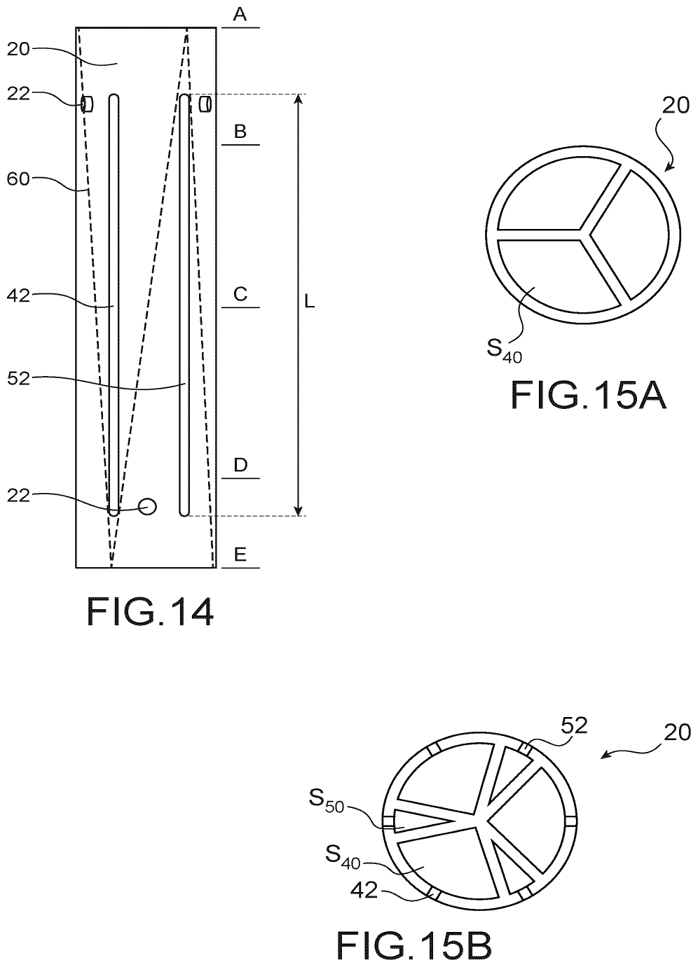

In a particularly advantageous manner, the hollow insert 20 can be provided with centring means maintaining the latter in a coaxial position with the hollow tube 10. For example, as shown in FIG. 14 relating to a second variant of the present invention discussed in the rest of the statement, the centring means comprise bumps 22 formed on the second wall 21.

These centring means 22 allow in particular to consider a hollow insert 20 with a length at least 20 times greater than the diameter of said insert. Furthermore, these centring means 22 also allow to facilitate the assembly of the tubular reactor 1.

The hollow insert 20 further comprises at least one distribution chamber 40 and at least one collection chamber 50. In particular, the hollow insert 20 may comprise between one and four distribution chambers 40, and between one and four distribution collection chambers 50.

The distribution chambers 40 and the collection chambers 50 are advantageously disposed alternately, extend over the entire length of the hollow insert 20 and are separated from each other by separating walls 60.

More particularly, the separating walls 60 extend over the entire length of the hollow insert 20 in the volume defined by the hollow insert 20.

Moreover, the at least one distribution chamber 40 comprises an admission opening 41 at one end of the insert 20 through which one or more reactive gases can be admitted.

Equivalently, the at least one collection chamber 50 comprises an evacuation opening 51 at the other end of the hollow insert 20 and through which one or more gases can be evacuated.

The hollow insert 20 is also provided with at least one distributing or distribution opening 42, and at least one collecting or collection opening 52. In particular, the distributing opening 42 forms a passage permeable to reactive gases from the distribution chamber 40 towards the annular space 30. Equivalently, the collecting opening 52 forms a passage permeable to gases from the annular space 30 towards the collection chamber 50. The distribution 42 and collecting 52 openings extend over a length L. Advantageously, the length L is greater than half, advantageously three-quarters of the extension length along the longitudinal axis XX′ of the annular space 30. Moreover, the at least one distribution chamber 40 is closed at the second end 12, while the at least one collection chamber 50 is closed at the first end 11. In this regard, as illustrated in FIG. 1, the distribution chamber 40 is closed by a distribution wall 43, while the collection chamber 50 is closed by a collection wall 53.

Complementarily, the tubular reactor 1 may comprise at the first end 11 and at the second end 12, respectively, a distributing space 13 and a collecting space 14 between which the hollow insert 20 is disposed.

Advantageously, the collecting opening 42 and the distributing opening 52 have a width comprised between 1/100 and ½, advantageously comprised between 1/20 and ¼, of the diameter of the hollow tube 10.

In accordance with the invention, each collecting opening 52 and each distributing opening 42 are also associated with one or more filter elements 61 preventing the passage of catalytic powder into either one of the collection 50 or distribution chambers 40. Precisely, this or these filter elements 61 allow to confine the catalyst in the annular space 30 due to their impermeability to the catalyst.

For example, and as illustrated in FIG. 3, a filter element 61 can be in the form of a filter, in particular a filter sheet, which can comprise a plurality of planes 61a, 61b, 61c and 61d comprising fibres. The example illustrated in FIG. 3 comprises in particular four planes, each provided with rectangular or round fibres and inclined at plus or minus 45° relative to the longitudinal axis XX′. More particularly, the fibres of two successive planes are oriented at two different angles, and are in particular perpendicular from one plane to the other.

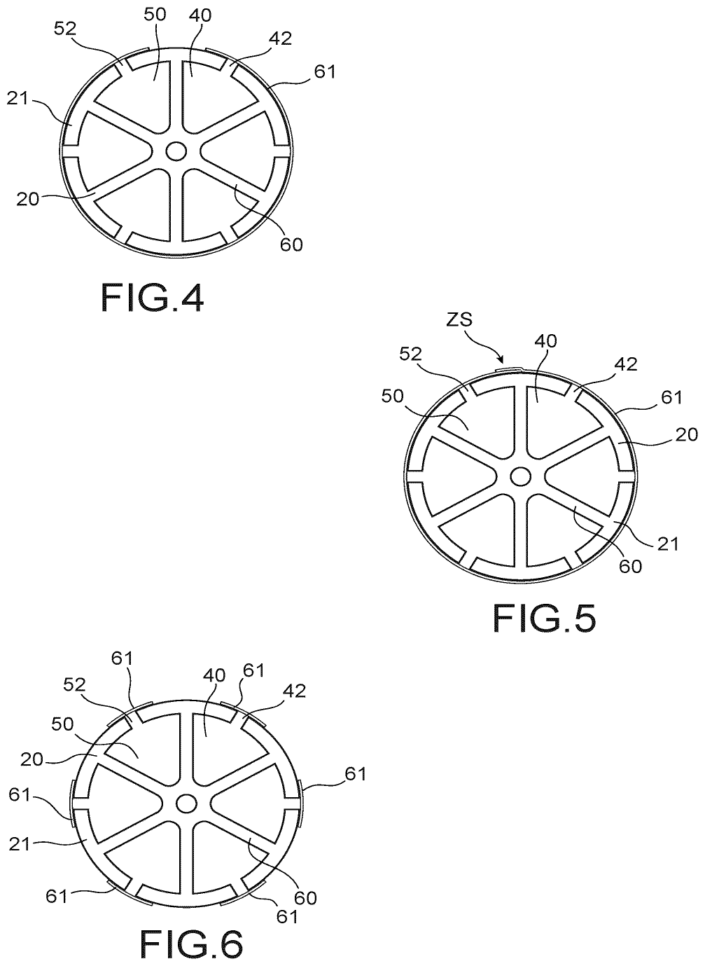

FIGS. 4 to 11 illustrate different embodiments of one or more filter elements 61 which can be used in any type of reactor 1 in accordance with the invention.

This filter element(s) 61 are positioned at each collecting opening 52 between a collection chamber 50 and the annular space 30, as well as at each distributing opening 42 between a distribution chamber 40 and the annular space 30. They advantageously allow to confine the catalyst within the annular space 30 and therefore to prevent the passage of catalytic powder from the annular space 30 to the collection chambers 50 and the distribution chambers 40.

As illustrated in FIGS. 4 to 6, the filter element(s) 61 may be in the form of one or more filter sheets 61 positioned to bear against the outer surface of the second wall 21 of the hollow insert 20.

Then they completely cover the collecting openings 52 and the distributing openings 42 by bearing on the outer surface of the second wall 21 on either side of said openings. In other words, the filter sheet(s) 61 may be similar to one or more filters wound around the insert 20 and covering the collecting openings 52 and the distributing openings 42.

This or these filter sheets 61 may for example include a fabric, a felt, for example made of glass fibres, metal fibres, carbon fibres, a grid and/or a micro-perforated metal or ceramic sheet. In particular, in the case of a grid or a micro-perforated sheet, the size of the meshes or the porosities is less than the diameter of the catalyst particles. Note that a fabric or a grid of low thickness, comparable to the size of the particles, typically between 20 μm and 1 mm, positioned with a minimum of clearance relative to the surface of the insert 20 are preferred in order to not to promote the circulation of the gas in the thickness of the filter sheet(s) 61, or between the latter and the insert 20, which would prevent the gas from being contacted with the catalyst (and therefore limit the reaction), and so as not to thermally isolate the catalyst from the wall of the insert 20, which would limit the homogenisation of the temperature in the reactor 1 and would encourage the appearance of hot spots if the reaction is exothermic for example.

The use of one or more filter elements 61 in the form of one or more filter sheets 61 allows to use a very simple shape of insert 20, typically with a circular section, and in particular with a convex shaped contour so as not to create a space between the insert 20 and the filter sheet(s) 61.

As illustrated in FIG. 4, a filter sheet 61 can be provided, the latter covering all the collecting 52 and distributing 42 openings without covering the entire outer surface of the second wall 21. Thus, the filter sheet 61 can be presented in an open cylindrical form, or else in the form of an open tube, and can fit around the insert 20 like a sock. The perimeter of the insert 20 is not entirely covered by the filter sheet 61.

Alternatively, as illustrated in FIG. 5, the filter sheet 61 can also completely cover the circumference of the insert 20, so as to be wound all around the insert 20, and be closed on itself at a superposition zone ZS of the ends of the filter sheet 61. The periphery of the insert 20 is entirely covered by the filter sheet 61.

Moreover, as illustrated in FIG. 6, it is also possible to use a plurality of filter sheets 61, then constituting filter pieces in the form of portions of cylindrical shape, each covering a distributing opening 42 or a collecting opening 52.

The fixing of the filter sheet(s) 61, directly on the outer surface of the second wall 21 of the insert 20 and/or at the superposition zone ZS, can be done by spot welding or else by brazing. It is also possible to hold the filter sheet(s) 61 in place on the insert 20 by means of a ligature, for example composed of one or more metal wires wound around the insert 20 and the filter sheet(s) 61.

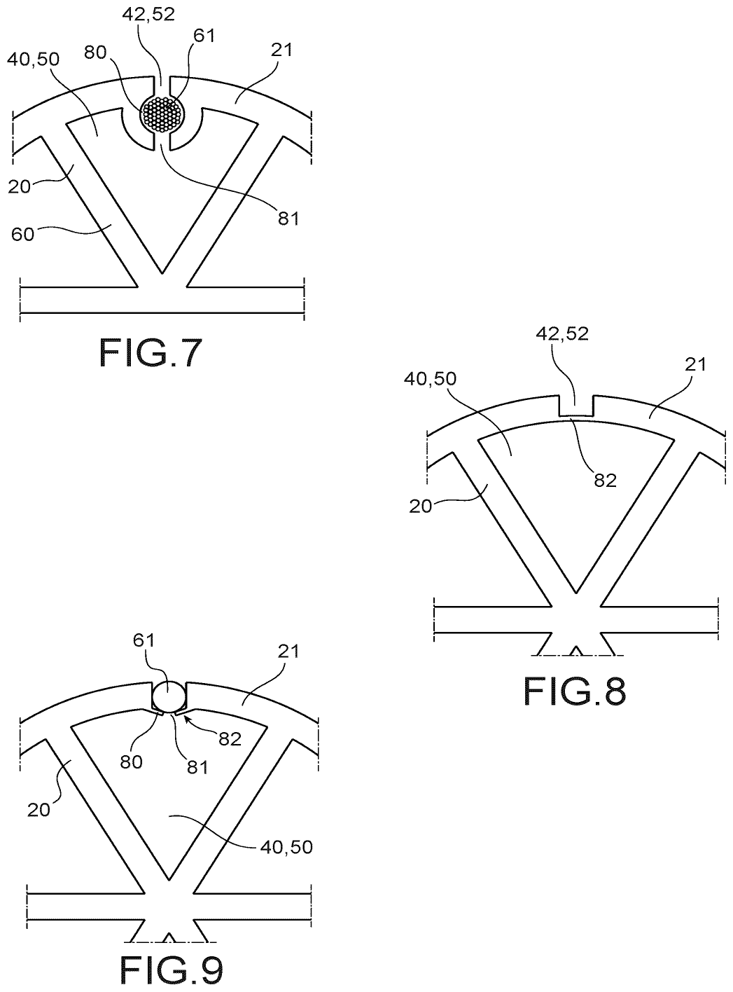

Furthermore, as illustrated in FIGS. 7 to 11, the filter element(s) 61 can still be housed at least partly inside a collecting opening 52 or a distributing opening 42.

In particular, the reactor 1 may include a compartment 80 at each of the collecting opening 52 and distributing opening 42. This compartment 80 may allow to house at least partly one or more filter elements 61. This compartment 80 is at least partly formed inside a collecting opening 52 or a distributing opening 42.

Advantageously, the filter element(s) 61 placed in a compartment 80 are in contact with the inner wall(s) of the compartment 80.

Each compartment 80 can be formed continuously over all or part of the length of the insert 20 along the longitudinal axis XX′. It is advantageously adjusted to the filter element(s) 61 which it must receive so as to retain the catalyst in the annular space 30.

Each compartment 80 further includes one or more openings 81, identified in FIGS. 7, 9, 10 and 11, allowing the circulation of gases through or around the filter element(s) 61, between the collection chamber 50 and the distribution chamber 40 and the annular space 30 containing the catalyst. Preferably, the opening(s) 81 are continuous along the length of the insert 20 so as to allow the installation of the filter element(s) 61 in the compartment 80.

Advantageously, the porosity of the filter element(s) 61 is smaller than the size of the particles of the catalyst. It performs the function of separation between the gases and the catalyst. This porosity is either a component of a porous material used in the filter element(s) 61, such as a fibrous material, wool, braid, foam, sinter, silica or metallic ceramic, steel or carbon, and the gases then circulate preferentially through the filter element(s) 61, or created by a space provided between the filter element(s) 61 and the compartment 80, the gases then circulating preferentially around the filter element(s) 61. The gas circulation space can be for example a mounting clearance of the filter element(s) 61 in their compartment 80, or created by a surface roughness of the compartment 80 or of the filter element(s) 61, for example a threaded rod or steel cable.

The dimension of the section of the filter element(s) 61 and of the compartment 80 is typically comprised between 1 mm and 5 mm. In addition, the section of the filter element(s) 61 can be round, square or rectangular, or even any other shape provided that it is adapted to the compartment 80 and does not allow the catalyst particles to migrate towards the distribution chamber 40 and the collection chamber 50.

Advantageously, the use of such compartments 80 each associated with one or more filter elements 61 makes it easier to place them in the insert 20, like a seal placed in a groove. In addition, the filter elements 61 can be held in position by friction with the wall(s) of the compartment 80 so that any other means of attachment can be avoided, such as welding, brazing or ligation. Moreover, the absence of filter element 61 on the entire outer surface of the second wall 21 of the insert 20 can allow to free this surface to attach other elements, for example intended to ensure centring relative to the tube 10. Furthermore, the absence of filter element 61 on the outer surface of the second wall 21 of the insert 20 can allow better transfer of heat between the bed of catalytic powder and the insert 20. It is also possible to use a thicker, less fragile and less expensive filter element. It is possible to install a filter element 61 with very small porosities generating resistance to the passage of gases which can be beneficial for homogenising the distribution of reactive gases over the entire length of the insert 20. Finally, it is possible to make the contour of the section of the insert 20 concave without creating a preferential gas passage between the insert 20 and the filter element 61.

In the examples of FIGS. 7, 10 and 11, the compartments 80 are formed by means of a local modification of the second wall 21 of the insert 20 at each collecting opening 52 and each distributing opening 42.

Precisely, in the example of FIG. 7, a compartment 80 is formed at a collecting opening 52 or distributing opening 42 by modification of the second wall 21, in particular by protrusion of the wall 21 towards the collection chamber 50 or distribution chamber 40 to form a compartment 80 of cylindrical shape, open on the collecting opening 52 or distributing opening 42 and open on the collection chamber 50 or distribution chamber 40 by means of a longitudinal opening 81. The compartment 80 can be made at the same time as the insert 20 and be made integrally therewith. It should be noted that the compartment 80 can also be formed by an element attached to the wall 21.

In this example, and in a non-limiting manner, the filter element 61 is in the form of a steel cable.

Advantageously, it may be possible to associate the creation of the compartment 80 with the production of the collecting opening 52 or distributing opening 42.

Thus, FIGS. 8 and 9 illustrate the case of a compartment 80 formed by means of a cut membrane 82 located in the collecting opening 52 or distributing opening 42. This membrane 82 can be attached or formed at the same time as the wall 21.

Precisely, the collecting opening 52 or distributing opening 42 includes a membrane 82, as visible in FIG. 8, which is then cut to obtain the opening 81 and to form the compartment 80 allowing to accommodate the filter element 61, as visible in FIG. 9.

For example, if the insert 20 is made by extrusion, the manufacturing method can allow to provide such a membrane 82 of material allowing to initially obstruct the collecting opening 52 or distributing opening 42. The passage of a blade can then allow to create the opening 81 which will leave one or two parts of membrane, as shown, allowing to form, with the edges of the wall 21 in the opening 42 or 52, the compartment 80 containing the filter element 61.

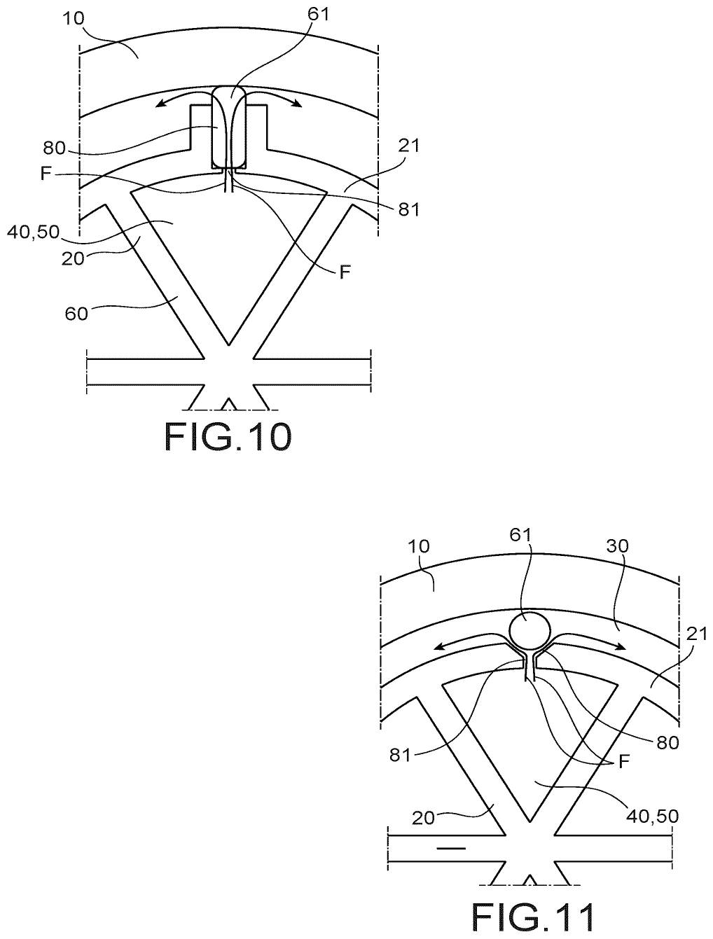

Furthermore, in the exemplary embodiment of FIG. 10, the compartment 80 is formed by a local modification of the second wall 21 consisting of a protrusion thereof on either side of the collecting opening 52 or distributing opening 42 within the annular space 30. The bottom of the collecting opening 52 or distributing opening 42 is also pierced to form the opening 81 allowing the passage of gas flows F.

In addition, the exemplary embodiment of FIG. 11 shows a compartment 80 formed by a flare in the second wall 21 on either side of the collecting opening 52 or distributing opening 42 to receive the filter element 61, here under threaded rod shape. The collecting opening 52 or distributing opening 42 is then partly formed by the compartment 80 which comprises an opening 81 for the passage of gases F.

In these two exemplary embodiments of FIGS. 10 and 11, the filter element 61 is advantageously in contact with the hollow tube 10. It is therefore blocked between the hollow tube 10 and the compartment 80. In this way, it may be possible to achieve centring the insert 20 relative to the hollow tube 10. Indeed, it is necessary to control the thickness of the annular space 30 filled with catalyst. This function, instead of being provided by an element attached to the surface of the insert 20 such as that element 22 subsequently described with reference to FIG. 14, can be directly provided by the compartment 80 or the filter element 61.

In these particular examples, the compartment 80 and/or the filter element 61 project from the outer surface of the insert 20 and are inscribed in a circle with a radius slightly smaller than that of the inner wall of the hollow tube 10. For example, the difference between the two radii is less than one fifth of the thickness of the targeted annular space 30. Thus, in the case where the insert 20 includes for example six chambers, only three can be equipped with a compartment 80 and a filter element 61 of this type, which is sufficient to centre the insert 20.

During the operation of the reactor 1, one or more reactive gases are admitted into the distribution chamber 40 through the admission opening 41. These gases then pass through the distributing opening 42 and flow into the annular space 30 in order to be contacted with the bed of catalytic powder. During this flow in the annular space 30, which occurs essentially between a distributing opening 42 and a collecting opening 52 which is immediately adjacent thereto, the reactive gases are converted, at least in part, into products. The latter, as well as the fraction of reactive gases which have not reacted, pass through the collecting opening 52 thus considered and are collected in the collection chamber 50. The products and reactive gases which have not reacted thus collected are then evacuated through the evacuation opening 51.

Thus, the extent of the distributing openings 42 over the length L allows to distribute the reactive gases in the annular space 30 over said length L. In other words, this arrangement allows to distribute the amount of heat likely to be produced during the conversion of the reactive gases into products over the entire length L. This arrangement thus allows to limit the local temperature increase of the catalytic powder bed. The extent over the length L of the collecting openings 52 allows, according to an equivalent principle, to limit the heating of the bed of catalytic powder.

Moreover, the arrangement of the admission 41 and discharge 51 openings on opposite ends of the hollow insert 20 also contributes to better distribution of the reagents within the annular space 30 and consequently to a better homogenisation of the temperature of the catalytic powder bed.

All these aspects help to limit the appearance of hot spots and thus preserve the catalytic powder bed. This results in better reliability of the tubular reactor 1 and an increase in its lifespan.

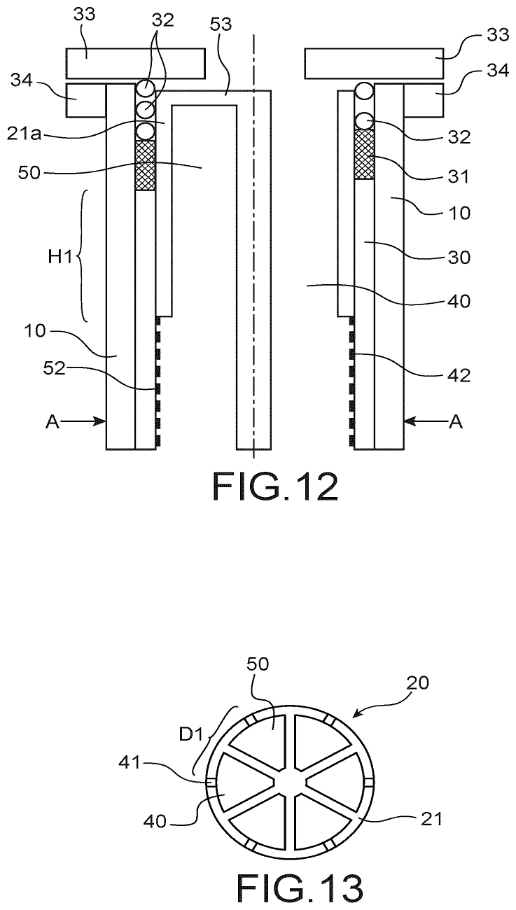

According to a particularly advantageous aspect illustrated in FIG. 12, the catalytic powder is retained in the annular space 30 by a seal 31 made of fibrous material at each of the ends of the annular space 30.

To the extent that the seal is made of fibrous material, the latter is necessarily porous and therefore permeable to reactive gases. The fibrous material may in this regard comprise at least one of the elements selected from: glass fibres, ceramic fibres, metal fibres, carbon fibres, polymer material fibres, among others.

The seal 31 may in particular be in the form of a braid, a sheath, a cord or simply comprise a filling of the fibrous material. The fibrous material is advantageously a thermal insulator and has a thermal conductivity substantially equivalent to that of the catalyst used (0.2 W/m/K to 10 W/m/K).

According to an advantageous embodiment, the seal 31 made of fibrous material is held in compression against the catalytic powder by a spring 32. For example, the spring 32 abuts against a retaining plate 33 mechanically connected to the tube 10 by a ring 34.

The seal 31 made of fibrous material in combination with the spring(s) 32 allows to better compact the catalytic powder and to prevent attrition of the latter during handling or transport of the reactor.

To the extent that the seal 31 is porous, the reactive gases can penetrate into the annular space directly without passing through the distribution chamber 40.

In this case (FIG. 12), it is particularly advantageous to provide an arrangement of the hollow insert 20 allowing to impose on this reactive gas a predetermined path in the annular space 30 in order to promote its conversion upon contact of the catalytic powder bed. This predetermined path has a length comprised between 0.2 times and 10 times, advantageously comprised between 1 time and 2 times, the distance D1 (FIG. 13) separating a distributing opening 42 from an immediately adjacent collecting opening 52, and measured along the outer surface of the second wall 21 of the insert 20.

To this end, the second wall 21 may have no opening on a first section 21a and a second section which extend, respectively, from the first end 11 and the second end 12. In this regard, the first section 21a and the second section overlap with the powder bed over a height H1. The height H1 being comprised between 0.5 times and 10 times, advantageously between one time and 2 times, the distance D1 separating a distributing opening 42 from an immediately adjacent collecting opening 52, and measured along the outer surface of the second wall 21.

FIG. 14 illustrates a second variant of the present invention which essentially repeats the features of the first variant. The hollow insert 20 relating to this second variant is advantageously manufactured using an additive manufacturing technique.

According to this second variant, the distribution chamber 40 has a converging profile from the first end 11 towards the second end 12.

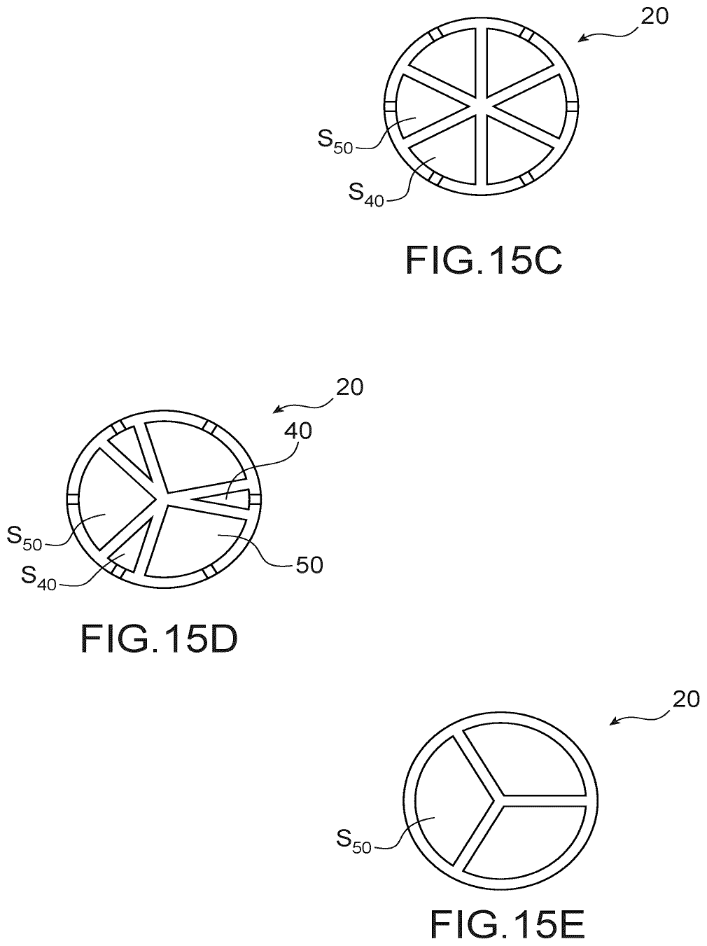

In other words, the surface S40 of a section of the distribution chamber 40 along a section plane transverse to the longitudinal axis XX′ decreases from the first end 11 towards the second end 12 (FIGS. 15A to 15E), advantageously, the surface is zero at the second end 12.

Equivalently, the surface S₅₀ of a section of the collection chamber 50 along a section plane transverse to the longitudinal axis XX′ increases from the first end 11 towards the second end 12, advantageously, the surface is zero at the first end 11.

This arrangement of the distribution chamber 40 and the collection chamber 50 allows to minimise pressure losses related to the circulation of gases. The flow inhomogeneities in the annular space 30 are thus reduced.

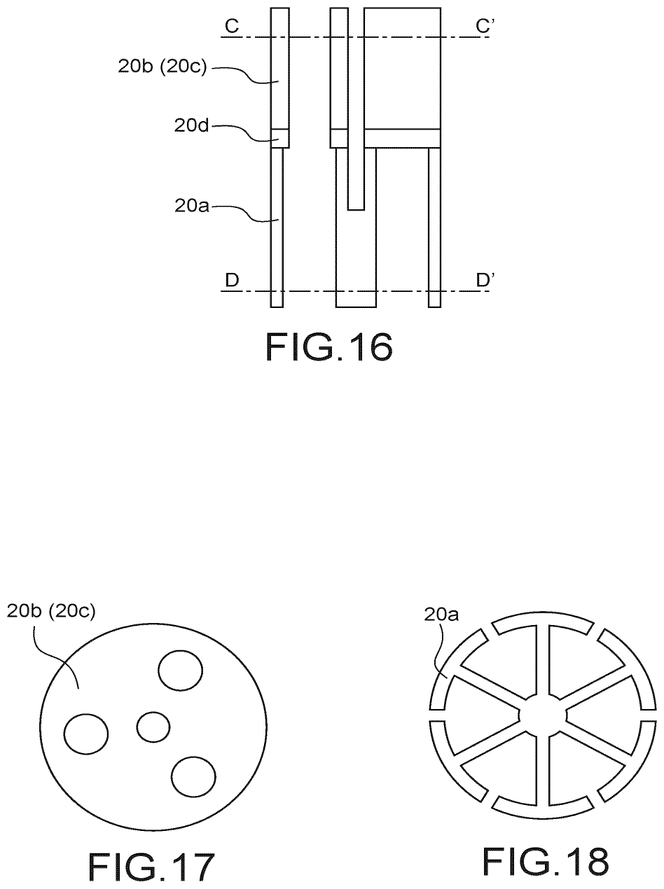

FIG. 16 shows a hollow insert 20 capable of being implemented according to a third variant of the present invention. This third variant essentially incorporates the features relating to the first and the second variant.

The insert 20 relating to this second variant can be manufactured by machining, by cutting, by electroerosion, by extrusion, among others.

In particular, the insert 20 comprises according to this variant a main body 20a interposed between two terminal bodies 20b, 20c, and assembled by means of a joint 20d.

The two terminal bodies 20b, 20c, illustrated in FIG. 16, comprise a cylindrical wall not permeable to gas reproducing the first section 21a described in the context of the first variant, and comprises distribution 42 (or collection 52) openings.

The tubular reactor according to the present invention is advantageously used for the synthesis of methane, methanol, dimethyl ether or else to implement the Fisher-Tropsch synthesis.

Of course, the invention is not limited to the embodiments which have just been described. Various modifications can be made thereto by the person skilled in the art.

1-12. (canceled)

13. A fixed-bed tubular reactor which extends, along a longitudinal axis, between a first end and a second end, comprising
a bed of catalytic powder confined within an annular space delimited by a first wall of a hollow tube and a second wall of a hollow insert, disposed in the hollow tube and coaxially with the hollow tube, wherein
the hollow insert comprises at least one distribution chamber and at least one collection chamber, separated from each other by a separating wall, and comprising, respectively, a gas admission opening at the first end and a gas evacuation opening at the second end,
the second wall comprises at least one distributing opening and at least one collecting opening, which extend over a length, the distributing opening allowing the distribution of a gas capable of being admitted through the admission opening of the distribution chamber towards the annular space, and the collecting opening allowing the collection of the gas distributed in the annular space by the collection chamber,
the reactor includes at least one filter element positioned at said at least one collecting opening between said at least one collection chamber and the annular space, as well as at the at least one distributing opening between said at least one distribution chamber and the annular space, the at least one filter element preventing passage of catalytic powder from the annular space respectively to said at least one collection chamber and said at least one distribution chamber, and
the at least one filter element is housed at least partially inside the at least one collecting opening and the at least one distributing opening.

14. The reactor according to claim 13, wherein the reactor includes at least one compartment at each of the at least one collecting opening and the at least one distributing opening, the at least one filter element being at least partly housed inside the at least one compartment of the at least one collecting opening and of the at least one distributing opening.

15. The reactor according to claim 14, wherein one of the at least one filter element is introduced inside each compartment, in contact with inner wall(s) of the compartment.

16. The reactor according to claim 14, wherein each compartment includes one or more openings allowing circulation of gases.

17. The reactor according to claim 14, wherein one or more compartments are formed using a local modification, at one or more collecting and distributing openings, of the second wall of the hollow insert.

18. The reactor according to claim 14, wherein one or more compartments are formed using a cut membrane placed in one or more collecting and distributing openings.

19. The reactor according to claim 13, wherein the at least one filter element contacts the hollow tube so as to allow centring the hollow insert relative to the hollow tube.

20. The reactor according to claim 14, wherein the compartment(s) and the hollow insert form a single piece.
